(19) United States
(12) Patent Application Publication
(10) Pub. No.: US 2007/0045092 A1
(43) Pub. Date: Mar. 1, 2007

(54) Device and method for selectively relieving pressure exerted upon a member

(76) Inventors: Andrew M. Voto, Brighton, MI (US); Ronald K. Selby, Flint, MI (US); Kenneth D. Perry, New Lothrop, MI (US); David A. Ross, Columbiaville, MI (US); Alfred V. Dumsa JR., Brighton, MI (US); Raymond H. Cottrell, Eden Prairie, MN (US)

Correspondence Address: DELPHI TECHNOLOGIES, INC., M/C 480-410-202, PO BOX 5052, TROY, MI, 48007, US

(21) Appl. No.: 11/216,909

(22) Filed: Aug. 31, 2005

(51) Int. Cl. H01H 57/00

(52) U.S. Cl. 200/181

(57) ABSTRACT

A device for selectively relieving pressure exerted upon a member is disclosed. The device includes at least one housing and an electroactive polymeric material disposed within the at least one housing. The electroactive polymeric material is configured to expand when exposed to an electric field such that at least some of the pressure exerted upon the member is relieved.

### BACKGROUND

The present disclosure relates generally to pressure relief, and more particularly to a device and method for selectively relieving pressure exerted upon a member.

When a person sits or lies in substantially the same position over a period of time, pressure may be exerted upon certain areas of the person's body. People who have substantially full mobility and nerve sensation will likely adjust their position to reduce stress on tissues and to allow blood to flow to areas that may have been restricted due to the pressure. However, when a person is bed-ridden or confined to a wheelchair, his nerve sensation is substantially reduced, and he is likely to sit or lie in the same position until another person is able to assist in moving him to a different position. Without periodic movement, the person is likely to suffer from tissue damage, due in part, to decreased blood flow to high pressure points.

Attempts to adjust positions of a bed- or chair-ridden person include providing actuators in the bed or chair that tip the person to a different position. The tipping is supposed to shift pressure to a different portion of the person's body. The angle to which the person is shifted may be severe and uncomfortable. Further, the person may be shifted several times a day and for extended periods in order to allow blood to re-circulate to those areas that were under pressure.

As such, it would be desirable to provide a device capable of selectively relieving pressure exerted upon a member.

### SUMMARY

A device for selectively relieving pressure exerted upon a member is disclosed herein. The device includes at least one housing and an electroactive polymeric material disposed within the at least one housing. The electroactive polymeric material is configured to expand when exposed to an electric field such that at least some of the pressure exerted upon the member is relieved.

### BRIEF DESCRIPTION OF THE DRAWINGS

Objects, features and advantages of embodiments of the present disclosure will become apparent by reference to the following detailed description and drawings, in which like reference numerals correspond to similar, though not necessarily identical components. Reference numerals having a previously described function may not necessarily be described in connection with subsequent drawings in which they appear.

FIG. 1 is a schematic perspective view of an embodiment of a stack of housings having electroactive polymeric material therein;

FIG. 2 is a schematic perspective view of an embodiment of a stack of housings having expanded electroactive polymeric material therein;

FIG. 3 is a schematic perspective of an embodiment of a supporting device having a plurality of housing stacks thereon, with some electroactive polymeric materials expanded; and

FIG. 4 is a schematic perspective view of the supporting device of FIG. 3 with other electroactive polymeric materials expanded.

### DETAILED DESCRIPTION

Embodiment(s) of the device and method disclosed herein advantageously allow the selective relief of pressure exerted upon members, such as, for example, human body parts, animal body parts, manufacturing materials, laboratory materials, mechanical parts, and the like. When a member contacts the device, pressure may be exerted upon the member. The pressure may advantageously be relieved at predetermined areas by expanding and/or contracting electroactive polymeric material(s) in the device. Embodiment(s) of the device may advantageously be used in any application where controlled support and/or pressure relief is desirable, including, but not limited to various medical applications, manufacturing applications, or laboratory applications.

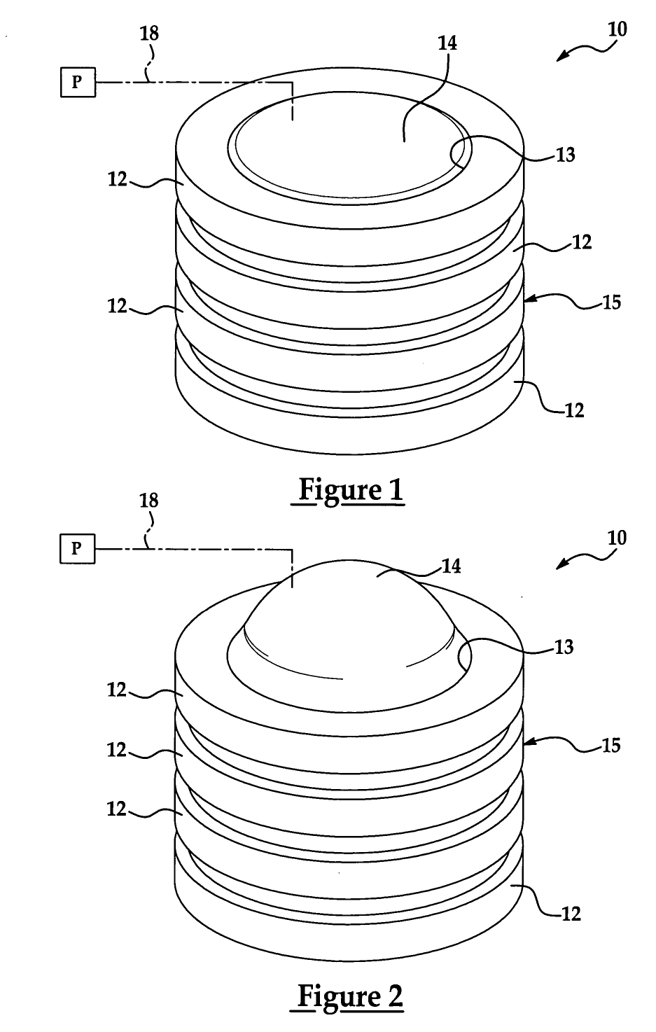

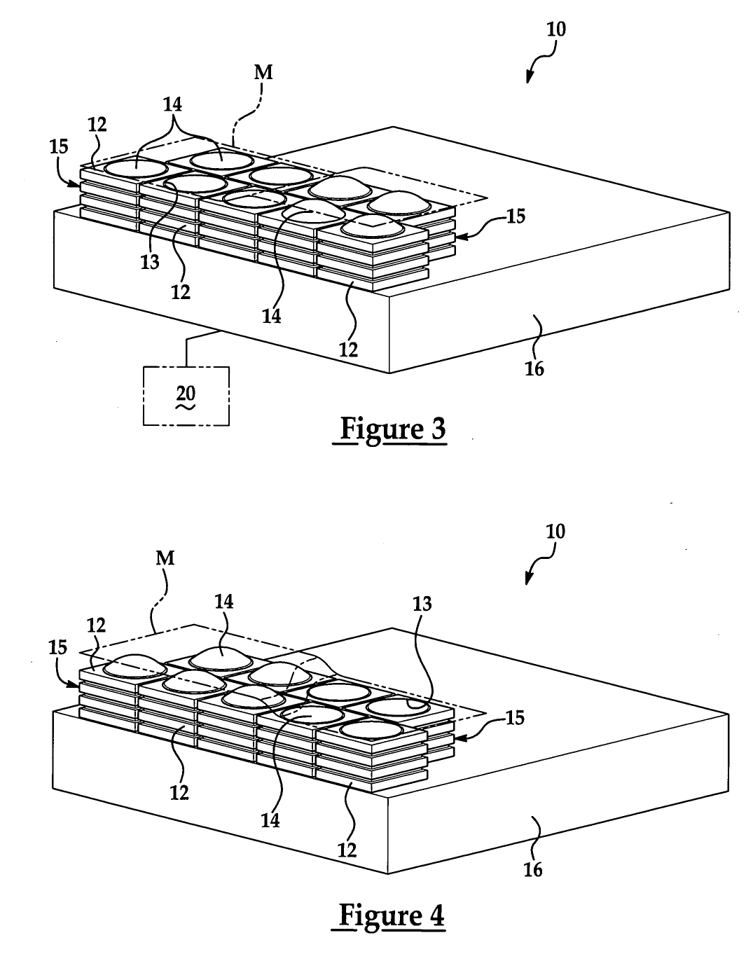

Referring now to FIGS. 1 and 2 together, an embodiment of the device 10 is depicted, both in a contracted position (FIG. 1) and in an expanded position (FIG. 2). The device 10 may be used for selectively relieving pressure exerted upon a member M (as seen in FIGS. 3 and 4). Embodiments of the device 10 shown in FIGS. 1 and 2 generally include a stack 15 of housings 12 and electroactive polymeric material 14 disposed within each housing 12. The stack 15 advantageously provides a larger displacement of the material 14 than a single housing 12. Alternate embodiments of the device 10 (not shown) include a single housing 12 having electroactive polymeric material 14 disposed therein.

The housing(s) 12 may be formed of any suitable material. In an embodiment, the housing(s) 12 is made of an engineering grade thermoplastic material having desirable structural and/or thermal properties. Further, the housing(s) 12 may have any suitable size, shape, geometry and/or configuration. It is to be understood that the housing(s) 12 may be designed to advantageously assist in controlling the form and/or position of the expanded electroactive polymeric material 14 (see FIG. 2). In a non-limitative example, the housing(s) 12 has a substantially rigid frame that substantially surrounds the electroactive polymeric material 14 such that the electroactive polymeric material 14 is able to expand in a predetermined direction. In an embodiment, the predetermined direction is determined by an aperture 13 in the housing(s) 12 (and stack 15) through which the electroactive polymeric material 14 may expand.

The electroactive polymeric material 14 is configured to respond to an external electrical field. Non-limitative examples of suitable electroactive polymeric materials 14 include polyurethanes, silicones, fluorosilicones, acrylics, isoprenes, and/or combinations thereof. When the electric field is selectively applied to the electroactive polymeric material 14, the material 14 is excited and expands in a predetermined direction (shown in FIG. 2). The electric field may be applied via electrical leads 18 (e.g. electrode(s)) that are operatively connected to the electroactive polymeric material 14. Generally, the field may be supplied to the electrical leads 18 via a circuit that is designed to allow a user to selectively control the applied field. Electrical leads 18 are shown schematically in FIGS. 1 and 2 attached to a power source P and to electroactive polymeric material 14. It is to be understood that this schematic representation is illustrative, and that the leads 18 may be operatively connected to electroactive polymeric material 14 at any suitable location and by any suitable route (for example, through the housing(s) 12), as desired.

The electroactive polymeric material 14 may be positioned within the housing(s) 12 such that the expansion and contraction of the material 14 is substantially controllable. In an embodiment, the electroactive polymeric material(s) 14 substantially retracts into the housing(s) 12 in the contracted position (FIG. 1) and expands outside of the housing(s) 12 in the expanded position (FIG. 2). In a non-limitative example, the material 14 expands up to about 20% from its original (non-contracted) size.

After a predetermined time, the expanded material 14 may be contracted. Contraction may be accomplished via removal of the electric field. In one embodiment, the electric field may be applied to the material 14 until contraction is desired. As such, the contraction results from the removal of the electric field.

The electric field may be applied or removed by any suitable actuator/actuating device operatively connected to the device 10.

The predetermined time in which the material 14 is expanded may be determined, at least in part, by a user of the device 10, by the material 14 selected, and/or combinations thereof. For example, the material 14 may contract substantially spontaneously after the user removes the electric field.

Referring now to FIGS. 3 and 4 together, an alternate embodiment of the device 10 is depicted. In this embodiment, the device 10 includes a plurality of stacks 15, where each housing 12 in the stack 15 has electroactive polymeric material 14 therein. It is to be understood that each of the electroactive polymeric materials 14 in the stacks 15 (or housings 12) may be independently addressable via the electric field.

In an embodiment, the plurality of stacks 15 is positioned on a supporting device 16 in a predetermined pattern. It is to be understood that single housings 12 (in addition to or as opposed to stacks 15) may be positioned on the supporting device 16 in a predetermined pattern. The predetermined pattern may include stacks 15 (and/or single housings 12) covering the entire supporting device 16, or may include stacks 15 (and/or single housings 12) arranged in a particular pattern for a desired end use.

The supporting device 16 may have any size, geometry, and/or configuration, for example, the shape of a bed, a seat of a chair (e.g. a wheelchair), a couch cushion(s), and/or the like. Supporting device 16 may be mounted to, or integrally formed with a bed, a chair, couch, etc. Further, the housings 12 on the supporting device 16 may be covered with a cushion (not shown) or other material that would make the device 10 substantially comfortable for sitting or lying down.

FIGS. 3 and 4 also depict an embodiment of a method for selectively relieving pressure exerted upon a member M by the device 10. Generally, the device 10 is capable of having a member M sitting or lying thereon, whereby pressure is exerted on the member M by the device 10. In order to relieve at least some of the pressure from the member M, predetermined areas (e.g. some or all of electroactive polymeric material 14 in the housings 12) of the device 10 may be expanded. Generally, the pressure is relieved at an area of the member M adjacent the expanded electroactive polymeric material 14.

The method includes selectively exposing one or more electroactive polymeric materials 14 to the electrical field. It is to be understood that the application of the electric field may be dependant upon, at least in part, the area of the member M where pressure relief is desirable.

In the embodiment shown in FIG. 3, some of the electroactive polymeric materials 14 are exposed to the electric field in a first predetermined pattern such that the electroactive polymeric materials 14 are expanded in the first predetermined pattern. As depicted, when some of the electroactive polymeric materials 14 are expanded, others remain contracted. In this embodiment, pressure is relieved on an area of the member M adjacent the expanded materials.

FIG. 4 depicts the contraction of those materials 14 that were expanded in FIG. 3 and the expansion of other materials 14 (e.g. those not expanded in FIG. 3). The application of the electric field to other electroactive polymeric materials 14 may be in a second predetermined pattern such that the expansion of the other materials 14 also occurs in the second predetermined pattern.

It is to be understood that the contraction of some materials 14 and the expansion of other materials 14 may occur substantially simultaneously or sequentially. In a non-limitative example, the electric field applied to the expanded materials 14 is removed to allow their contraction, and a second electric field is applied to the contracted materials 14 to allow their expansion. It is to be understood that selectively varying which materials 14 that are contracted allows different areas of the member M to experience pressure relief.

The first and second predetermined patterns may include a time interval pattern of when the materials 14 are expanded and contracted and/or a physical configuration/spatial pattern in which materials 14 are expanded and contracted. As such, some or all of the materials 14 may remain expanded for a predetermined time and in a predetermined configuration. The predetermined pattern may be selected, at least in part, on the desired pressure relief.

In the embodiments disclosed herein, it is to be understood that a mechanical variation may be made to the device 10 to provide a mechanical advantage to the device 10. A non-limitative example of the mechanical advantage may be in the form of a relatively simple or a relatively complex lever system 20, schematically shown in FIG. 3. It is to be understood that the lever system 20 may be positioned such that it advantageously amplifies the 20% movement of the polymeric material 14, thereby providing additional movement. Without being bound to any theory, it is believed that altering the mechanics of the device 10 may provide various options for additional relief and/or may allow the actuator/actuating device to be positioned relatively remotely from the member M desiring pressure relief.

Embodiment(s) of the device 10 and method disclosed herein have many advantages, including, but not limited to the following. In using embodiment(s) of the device 10, pressure may be relieved on a member M (e.g. a person confined to a wheelchair) without having to adjust the member M itself. The pressure is advantageously relieved at predetermined areas of the member by expanding and/or contracting the electroactive polymeric material(s) 14 upon which the member M sits or lies, thereby eliminating the need to physically move the member M to a different position, as the materials 14 are moved instead. Still further, embodiment(s) of the device 10 may advantageously be used in any application where pressure relief is desirable, including, but not limited to various medical applications, manufacturing applications, and/or laboratory applications. The use of such a device in medical applications may reduce the number of bedsores and increase the quality of life of a bed- or chair-ridden patient.

While several embodiments have been described in detail, it will be apparent to those skilled in the art that the disclosed embodiments may be modified. Therefore, the foregoing description is to be considered exemplary rather than limiting.

What is claimed is:

1. A method for selectively relieving pressure exerted upon a member by a supporting device, the method comprising:
selectively exposing an electroactive polymeric material disposed within at least one housing to an electric field, thereby expanding the electroactive polymeric material such that at least some of the pressure exerted upon the member is relieved.

2. The method as defined in claim 1 wherein selectively exposing the electroactive polymeric material to an electric field is accomplished by electrically exciting the electroactive polymeric material via an electrical lead operatively connected to the electroactive polymeric material.

3. The method as defined in claim 1 wherein the supporting device comprises a plurality of housings positioned thereon, each of the plurality of housings including electroactive polymeric material therein, and wherein each of the electroactive polymeric materials is independently addressable via the electric field.

4. The method as defined in claim 3, further comprising:
exposing at least some of the electroactive polymeric materials to the electric field in a first predetermined pattern, thereby expanding the at least some of the electroactive polymeric materials in the first predetermined pattern;
removing the electric field from the at least some of the electroactive polymeric materials, thereby allowing contraction of the at least some of the electroactive polymeric materials; and
exposing at least some other of the electroactive polymeric materials to the electric field in a second predetermined pattern, thereby expanding the at least some other of the electroactive polymeric materials in the second predetermined pattern;
wherein at least some of the pressure exerted upon the member is relieved at an area of the member adjacent the respectively expanded electroactive polymeric materials.

5. The method as defined in claim 1 wherein at least some of the pressure exerted upon the member is relieved at an area of the member adjacent the expanded electroactive polymeric material.

6. The method as defined in claim 1 wherein the electroactive polymeric material is selectively exposed to the electric field in a predetermined pattern.

7. The method as defined in claim 1, further comprising removing the electric field from the electroactive polymeric material, thereby allowing contraction of the expanded electroactive polymeric material.

8. The method as defined in claim 1 wherein the electroactive polymeric material expands up to about 20% from its original size when exposed to the electric field.

9. The method as defined in claim 1 wherein the electroactive polymeric material is expanded for a predetermined time interval.

10. A device for selectively relieving pressure exerted upon a member, the device comprising:
at least one housing; and
an electroactive polymeric material disposed within the at least one housing, the electroactive polymeric material configured to expand when exposed to an electric field such that at least some of the pressure exerted upon the member is relieved.

11. The device as defined in claim 10 wherein the expanded electroactive polymeric material is configured to contract when the electric field is removed.

12. The device as defined in claim 10, further comprising a plurality of housings disposed on a supporting device, each of the plurality of housings having electroactive polymeric material disposed therein.

13. The device as defined in claim 12 wherein the electroactive polymeric material in each of the plurality of housings is configured to expand with or independently of the electroactive polymeric material in each of the other plurality of housings.

14. The device as defined in claim 12 wherein the plurality of housings is positioned on the supporting device in a predetermined pattern.

15. The device as defined in claim 10 wherein the supporting device is a seat base or a bed base.

16. The device as defined in claim 10, further comprising:
a plurality of housings forming a stack, each of the plurality of housings having a sheet of electroactive polymeric material therein; and
a plurality of stacks disposed on a supporting device.

17. The device as defined in claim 10 wherein the at least one housing has a rigid frame of predetermined geometry surrounding the electroactive polymeric material.

18. The device as defined in claim 10 wherein electroactive polymeric material comprises at least one of polyurethanes, silicones, fluorosilicones, acrylics, isoprenes, and combinations thereof.

19. The device as defined in claim 10 wherein at least some of the pressure exerted upon the member is relieved at an area of the member adjacent the expanded electroactive polymeric material.
